(19) United States
(12) Patent Application Publication
(10) Pub. No.: US 2021/0096003 A1
(43) Pub. Date: Apr. 1, 2021

(54) SENSOR AND RFID HOUSING ENCLOSURE FOR THIN WALL COMPONENTS

(71) Applicant: CORNERSTONE INTELLECTUAL PROPERTY, Lake Forest, CA (US)

(72) Inventors: John Kang, Lake Forest, CA (US); Evelina Vogli, Lake Forest, CA (US); Ted Ward, Lake Forest, CA (US)

(21) Appl. No.: 16/584,085

(22) Filed: Sep. 26, 2019

(51) Int. Cl. G01D 11/24; C23C 4/06; C23C 4/11; C22C 45/10

(52) U.S. Cl. CPC G01D 11/245; C22C 45/10; C23C 4/11; C23C 4/06

(57) ABSTRACT

Embodiments disclosed herein relate to the production of a housing enclosure designed for sensors or RFIDS to be attached to thin-walled components in the oil and gas industries being sent downhole during drilling and extraction. A metal-based coating, which may be crystalline, amorphous, or partially amorphous in structure, is deposited onto a substrate in layers via thermal spraying. The coating may then be machined so that an opening is created to receive the sensor or RFID. The coating may also provide other functions such as wear, corrosion or erosion protection to the thin-walled components applied.

### CROSS-REFERENCE TO RELATED APPLICATIONS

Not Applicable.

### TECHNICAL FIELD

The presently disclosed embodiments generally relate to applying layers of a metallic-based coating onto a substrate through thermal spraying to create a housing for a sensor or RFID, which is then dug out and covered with a polymer-based top coat, resulting in a housing enclosure that can still transmit a signal, is wear-resistant, and meets the standard for friction, creating an industry-standard for sensor and RFID housing enclosures.

### BACKGROUND

Sensors or RFIDs are used to provide many different types of data for the components that go downhole for different purposes during the drilling and extraction of oil and gas. Sensors and RFIDs can provide valuable information, such as estimating drill length and equipment identification. They are physically vulnerable and must be secure and safe in whatever application they are used in, otherwise they will be physically damaged. However, in keeping the sensors or RFIDs safe, it is important that the signal transmission ability is not impaired, making it difficult to manufacture [Source: “RFID for Oil and Gas Industry: Applications and Challenges”; Felemban, E; Sheikh, A; International Journal of Engineering and Innovative Technology, Vol. 3, No. 5 (2013) p. 80 to 85].

The sensors or RFIDs are usually attached to the components by drilling a recess into the tube wall with threaded sides and inserting the sensors or RFIDs into the small enclosure created. However, this method is not possible for thin-walled components, because there was not enough wall thickness to accommodate the required space for the sensors or RFIDs. Other methods, such as attaching a smaller sensor or RFID behind the threads on the ID of the component, or housing the RFID or sensor in a polymer housing, failed as well because the sensor or RFID was unable to remain in place or was damaged during normal activity.

Compared to metallic alloy materials with a crystalline microstructure, amorphous metal alloys “[exhibit] many superior properties”, where “[t]he unique properties [of metallic glasses] originate from [their] random atomic arrangement . . . that contrasts with the regular atomic lattice arrangement found in crystalline alloys.” [Source: “Classification of Bulk Metallic Glasses by Atomic Size Difference, Heat of Mixing and Period of Constituent Elements and Its Application to Characterization of the Main Alloying Element”; Takeuchi, A.; Inoue, A.; Materials Transactions, Vol. 46, No. 12 (2005) pp. 2817 to 2829].

And, “[t]he mechanical properties of amorphous alloys have proven both scientifically unique and of potential practical interest, although the underlying deformation physics of these materials remain less firmly established as compared with crystalline alloys.” [Source: Mechanical behavior of amorphous alloys”; Schuh, C.; Hufnagel, T.; Ramamurty, U.; Acta Materialia 55 (2007) 4067 4109]. Further, “[t]he mechanics of metallic glasses have proven to be of fundamental scientific interest for their contrast with conventional crystalline metals, and also occupy a unique niche compared with other classes of engineering materials. For example, amorphous alloys generally exhibit elastic moduli on the same order as conventional engineering metals . . . but have room-temperature strengths significantly in excess of those of polycrystals with comparable composition . . . . The consequent promise of high strength with non-negligible toughness has inspired substantial research effort on the room-temperature properties of metallic glasses.” [Source: Mechanical behavior of amorphous alloys”; Schuh, C.; Hufnagel, T.; Ramamurty, U.; Acta Materialia 55 (2007) 4067 4109].

An amorphous metal alloy may be applied as a coating through thermal spraying, which includes but is not limited to high velocity oxygen-fuel spraying (HVOF), plasma spraying, and twin-wire arc spraying (TWAS), among others. Heated particles of a coating in powder or wire form may be sprayed over a substrate, creating an even coating that may be built up to a desired thickness. In order to accelerate powders to higher velocities finer powders below 20 μm are usually used. Carrier or processing gases include nitrogen or helium, while fuel can include hydrogen, methane, natural gas, or liquids such as kerosene. Thermal spraying is considered a suitable technique for depositing amorphous metal alloys, as the material's purity and amorphous structure is retained through this process and it may be applied to complicated substrate shapes [Source: “Warm spraying—a novel coating process based on high-velocity impact of solid particles”; Kuroda, S; Kawakita, J; Watanabe, M; Katanoda, H; Science and Technology of Advanced Materials (2009); 9(3)].

Accordingly, it would be desirable to develop a process of forming a housing enclosure for sensors or RFIDs where an amorphous metal alloy is deposited in layers on a substrate via thermal spraying and then subsequently machined to create an opening for the sensor or RFID, then enclosed under a polymer-based top-coat to hold the sensor or RFID within the opening while protecting it and transmitting data.

### SUMMARY

Embodiments relate to a device comprising a substrate and a first layer on the substrate, the first layer comprising an amorphous metal alloy, the first layer having a sensor in an opening within the first layer, wherein the first layer (a) does not reduce hardness, strength and toughness of the substrate; (b) has a coefficient of friction that is lower than that of the substrate; and (c) does not change a signal strength of a signal emitted from the sensor by more than 50%.

In an embodiment, the first layer does not change a signal strength of a signal emitted from the sensor by more than 60%, 70%, 80% or 90%.

In an embodiment, the substrate comprises a metal.

In an embodiment, the device further comprises a second layer covering the opening.

In an embodiment, the second layer comprises a polymer.

In an embodiment, the device comprises a component for drilling.

In an embodiment, the component comprises a pipe.

In an embodiment, the amorphous metal alloy comprises Fe_{100-(a+b+c)}(XₐY_{b}Z_{c}) where the X and the Y are selected from the group consisting of tungsten, molybdenum, chromium, niobium, vanadium and combinations of tungsten, molybdenum, chromium, niobium, vanadium, and titanium, said X being present in the range of 10-50 at. %, the Y is in the range of 10 to 30 at. %, while the Z is selected from the group consisting of boron, carbon, and combinations thereof, said third component being present in an amount of from about 0.5 to about 10 at. %.

In an embodiment, the amorphous metal alloy comprises Fe_{100-(a+b+c+d)}CrₐMo_{b}C_{c}B_{d}, wherein a is in the range of 10 at. % to 35 at. %; b is in the range of 10 at. % to 20 at. %, c is in the range of 2 at. % to 5 at. %; and d is in the balance of 0.5% at. % to 3.5 at. %.

In an embodiment, the amorphous metal alloys comprises Fe_{100-a(+b+c+d)}(Crₐ(Mn+Mo)_{b}(W+Si)_{c}(C+B)_{d}), wherein: a is in the range of 10 to 30 at. %, b is in the range of 10 to 20 at. %, c is in the range of 2 to l0 at. %, and d is in the range of 2 to l0 at. %.

In an embodiment, the amorphous metal alloy is combined with a plurality of unstabilized zirconium oxide particles distributed throughout a matrix.

In an embodiment, the sensor comprises an RFID sensor.

In an embodiment. the amorphous metal alloy comprises a hardness value of 750-1,400 HV.

In an embodiment, the coefficient of friction of the first layer is less than 0.5.

An embodiment relates to a method comprising manufacturing a device comprising obtaining a substrate, depositing a first layer on the substrate, and inserting a sensor in an opening in the first layer, the first layer comprising an amorphous metal alloy, wherein the first layer (a) does not reduce hardness, strength and toughness of the substrate; (2) has a coefficient of friction that is lower than that of the substrate; and (c) does not change a signal strength of a signal emitted from the sensor by more than 50%.

Embodiments relate to a method in which a housing or enclosure is created in a thin-walled drilling component where a thermally-sprayed coating may be deposited onto the component (acting as the substrate) in layers, until a housing or enclosure may be machined out and an RFID or sensor may be inserted. A polymer-based top-coat may be used to fill the exposed gap and hold the RFID or sensor in place while allowing the transmissions from the RFID or sensor to be sent to the reader. The layer of coating deposited via thermal spraying may also give the component benefits associated with amorphous metals, such as improved corrosion and wear resistance, high strength, and high toughness. This method may be compared favorably to the current method of attaching RFIDs or sensors to thin-walled components, being non-damaging to the integrity of the component and remaining undamaged during normal activity.

### BRIEF DESCRIPTION OF THE FIGURES

These and other features and advantages of the present invention will be better understood by reference to the following detailed description when considered in conjunction with the accompanying drawings wherein:

FIG. 1 shows a viscosity-temperature graph of a bulk solidifying amorphous alloy from the VIT-001 series of Zr—Ti—Ni—Cu—Be family.

FIG. 2 shows a time-temperature-transformation (TTT) cooling curve of a bulk solidifying amorphous alloy.

FIG. 3 shows an average RFID tag.

FIG. 4 shows a block diagram of a method for coating a component in order to build a housing/enclosure for a sensor or RFID using thermal spraying.

FIG. 5 shows thermal sprayed coatings with different thicknesses (1.80 mil; 2.150 mil; 3.200 mil).

FIG. 6 shows schematic diagrams of the thermal sprayed enclosures a) full ring and b) patch.

FIG. 7 shows an embodiment of a thermal sprayed housing/enclosure with an opening for placing sensors/RFIDs.

FIG. 8 shows another embodiment of a thermal sprayed housing/enclosure with an opening for placing sensor/RFIDS.

### DETAILED DESCRIPTION

### Definitions and General Techniques

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties, e.g., physical properties, than their crystalline counterparts. However, if the cooling rate is not sufficiently high, crystals may form inside the alloy during cooling, so that the unique benefits of the amorphous state can be lost. For example, one challenge with the fabrication of bulk amorphous alloy parts is the partial crystallization of parts due to either slow cooling or impurities prevalent in the raw alloy material. As a high degree of amorphicity (and, conversely, a low degree of crystallinity) is desirable in BMG parts, there is a need to develop methods for casting BMG parts having predictable and controlled amount of amorphicity.

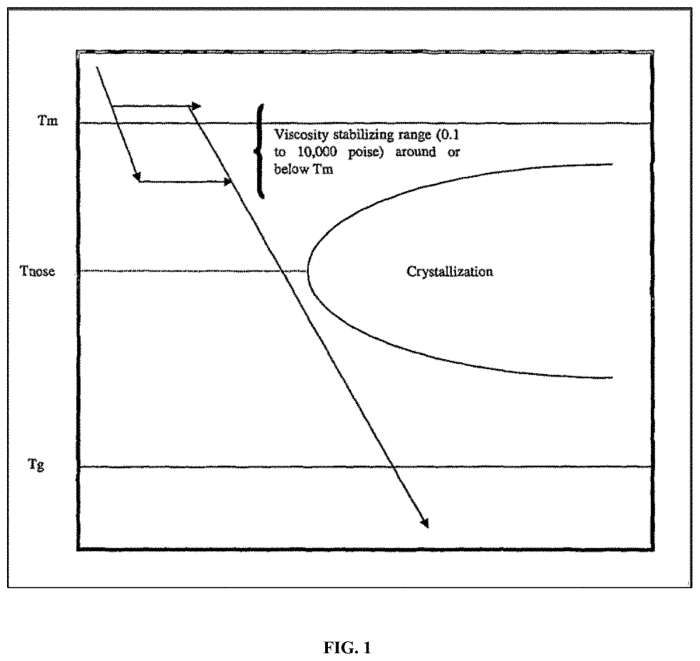

FIG. 1 (obtained from U.S. Pat. No. 7,575,040) shows a viscosity-temperature graph of a bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

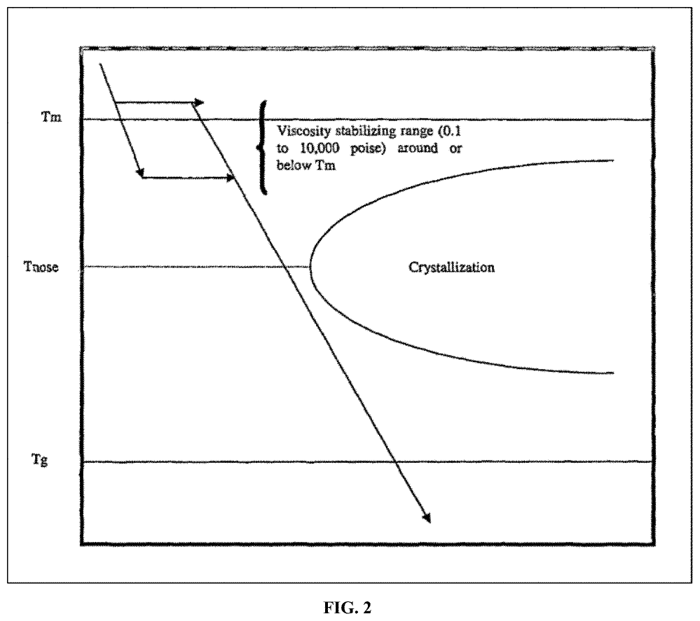

FIG. 2 (obtained from U.S. Pat. No. 7,575,040) shows a time-temperature-transformation (TTT) cooling curve 200 of a bulk solidifying amorphous alloy, or TTT diagram. Bulk-solidifying amorphous metals do not experience a liquid/solid crystallization transformation upon cooling, as with conventional metals. Instead, the highly fluid, non-crystalline form of the metal found at high temperatures (near a “melting temperature” Tₘ) becomes more viscous as the temperature is reduced (near to the glass transition temperature T_{g}), eventually taking on the outward physical properties of a conventional solid.

Even though there is no liquid/crystallization transformation for a bulk solidifying amorphous metal, a “melting temperature” Tₘ may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to be such that the time-temperature profile during cooling does not traverse through the nose-shaped region bounding the crystallized region in the TTT diagram of FIG. 2. In FIG. 2, Tₙₒₛₑ is the critical crystallization temperature Tₓ where crystallization is most rapid and occurs in the shortest time scale.

The supercooled liquid region, the temperature region between T_{g} and Tₓ is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 1012 Pa s at the glass transition temperature down to 105 Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tₓ. Technically, the nose-shaped curve shown in the TTT diagram describes Tₓ as a function of temperature and time. Thus, regardless of the trajectory that one takes while heating or cooling a metal alloy, when one hits the TTT curve, one has reached Tₓ. In FIG. 2, Tₓ is shown as a dashed line as Tₓ can vary from close to Tₘ to close to T_{g}.

The schematic TTT diagram of FIG. 2 shows processing methods of die casting from at or above Tₘ to below T_{g} without the time-temperature trajectory (shown as (1) as an example trajectory) hitting the TTT curve. During die casting, the forming takes place substantially simultaneously with fast cooling to avoid the trajectory hitting the TTT curve. The processing methods for superplastic forming (SPF) from at or below T_{g} to below Tₘ without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tₙₒₛₑ or below Tₙₒₛₑ, up to about Tₘ. If one heats up a piece of amorphous alloy but manages to avoid hitting the TTT curve, you have heated “between T_{g} and Tₘ”, but one would have not reached Tₓ.

Typical differential scanning calorimeter (DSC) heating curves of bulk-solidifying amorphous alloys taken at a heating rate of 20 C/min describe, for the most part, a particular trajectory across the TTT data where one would likely see a T_{g} at a certain temperature, a Tₓ when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tₓ upon heating. Another way to think about it is trajectories (2), (3) and (4) can fall anywhere in temperature between the nose of the TTT curve (and even above it) and the T_{g} line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function:

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can e of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt. %, such as at least about 40 wt. %, such as at least about 50 wt %, such as at least about 60 wt. %, such as at least about 80 wt. %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)ₐ(Ni, Cu)b(Be)_{c}, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One embodiment of the described alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1 and Table 2.

TABLE 1
Amorphous Alloy Compositions

| Alloy | At. % | At. % | At. % | At. % | At. % | At. % | At. % | At. % |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 5 | Pt | Cu | Ag | P | B | Si | | |
| | 74.70% | 1.50% | 0.30% | 18.0% | 4.00% | 1.50% | | |

TABLE 2
Additional Amorphous Alloy Compositions (Atomic %)

| Alloy | At. % | At. % | At. % | At. % | At. % | At. % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | | |
| | 50.75% | 36.23% | 4.03% | 9.00% | | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Zr | Ti | Fe | Be | | |
| | 35.00% | 30.00% | 2.00% | 33.00% | | |
| 13 | Au | Ag | Pd | Cu | Si | |
| | 49.00% | 5.50% | 2.30% | 26.90% | 16.30% | |
| 14 | Au | Ag | Pd | Cu | Si | |
| | 50.90% | 3.00% | 2.30% | 27.80% | 16.00% | |
| 15 | Pt | Cu | Ni | P | | |
| | 57.50% | 14.70% | 5.30% | 22.50% | | |
| 16 | Zr | Ti | Nb | Cu | Be | |
| | 36.60% | 31.40% | 7.00% | 5.90% | 19.10% | |
| 17 | Zr | Ti | Nb | Cu | Be | |
| | 38.30% | 32.90% | 7.30% | 6.20% | 15.30% | |
| 18 | Zr | Ti | Nb | Cu | Be | |
| | 39.60% | 33.90% | 7.60% | 6.40% | 12.50% | |
| 19 | Cu | Ti | Zr | Ni | | |
| | 47.00% | 34.00% | 11.00% | 8.00% | | |
| 20 | Zr | Co | Al | | | |
| | 55.00% | 25.00% | 20.00% | | | |

Other ferrous metal-based alloys include compositions such as those disclosed in U.S. Patent Application Publication Nos. 2007/0079907 and 2008/0118387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the composition Fe₄₈Cr₁₅Mo₁₄Y₂C₁₅B₆. They also include the alloy systems described by Fe—Cr—Mo—(Y, Ln)-C—B, Co—Cr—Mo—Ln-C—B, Fe—Mn—Cr—Mo—(Y, Ln)-C—B, (Fe, Cr, Co)—(Mo, Mn)—(C,B)—Y, Fe—(Co, Ni)—(Zr, Nb, Ta)—(Mo, W)—B, Fe—(Al, Ga)—(P, C, B, Si, Ge), Fe—(Co, Cr, Mo, Ga, Sb)—P—B—C, (Fe, Co)—B—Si—Nb alloys, and Fe—(Cr—Mo)—(C,B)—Tm, where Lₙ denotes a lanthanide element and Tₘ denotes a transition metal element. Furthermore, the amorphous alloy can also be one of the compositions Fe₈₀P_{12.5}C₅B_{2.5}, Fe₈₀P₁₁C₅B_{2.5}Si_{1.5}, Fe_{74.5}Mo_{5.5}P_{12.5}C₅B_{2.5}, Fe_{74.5}Mo_{5.5}P₁₁C₅B_{2.5}Si_{1.5}, Fe₇₀Mo₅Ni₅P_{12.5}C₅B_{2.5}, Fe₇₀Mo₅Ni₅P₁₁C₅B_{2.5}Si_{1.5}, Fe₆₈Mo₅Ni₅Cr₂P_{12.5}C₅B_{2.5}, and Fe₆₈Mo₅Ni₅Cr₂P₁₁C₅B_{2.5}Si_{1.5}, described in U.S. Patent Application Publication No. 2010/0300148.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Publication No. 2001303218 A). One composition is Fe₇₂Al₅Ga₂P₁₁C₆B₄. Another example is Fe₇₂Al₇Zr₁₀Mo₅W₂B₁₅. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. An example of such a practice would be that of adding tungsten carbide particles to an amorphous alloy in order to increase the alloy's hardness while maintaining ductility. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between T_{g} and Tₓ, for example. Herein, Tₓ and T_{g} are determined from standard DSC measurements at typical heating rates (e.g. 20° C./min) as the onset of crystallization temperature and the onset of glass transition temperature.

The amorphous alloy components can have the critical casting thickness and the final part can have thickness that is thicker than the critical casting thickness. Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature Tₓ. The cooling step is carried out at rates similar to the heating rates at the heating step, and preferably at rates greater than the heating rates at the heating step. The cooling step is also achieved preferably while the forming and shaping loads are still maintained.

### Amorphous Alloy Additive Manufacturing (3D Printing)

Amorphous alloys and bulk amorphous alloys may be used as a feedstock material for advanced manufacturing techniques such as additive manufacturing, an industrial production technology that has developed from advances in 3D printing regarding precision, repeatability and material range. Additive manufacturing, generally, refers to a transformative approach to traditional industrial production that enables the fabrication of parts demonstrating desirable physical properties, including improvements in strength and weight reduction when compared to parts made through conventional manufacturing.

3D printing refers to any one or more of the various processes in which material may be joined, glued, adhered, or otherwise solidified under computer control to create a 3D object, with source/feedstock material being added together (e.g., liquid molecules, or powder grains being fused together), typically in a layer-by-layer manner. Objects printed by 3D printing can now have a very complex shape or geometry and typically are produced based on a digital 3D model or a computer-aided-design (CAD) file.

Although there are several 3D printing processes, all 3D printing processes or production techniques can generally be categorized into the following seven categories: (1) vat photopolymerization; (2) material jetting; (3) binder jetting; (4) powder bed fusion; (5) material extrusion; (6) directed energy deposition; and (7) sheet lamination. Also, fused deposition modeling (FDM) has gained prominence regarding the fabrication of metal parts in the 3D printing industry. In FDM, material is added layer-by-layer, instead of conventional machining which may require material to be removed from an item, or traditional casting and forging processes.

General principles governing additive manufacturing or 3D printing may include the following: (1) modeling; (2) printing; (3) finishing; as well as: (4) multi-material printing. Regarding modeling, 3D printable models may be created with the aid of a CAD package through a 3D scanner, or by a digital camera used with photogrammetry software. Printing often involves a layer-by-layer deposition of material according to computer-aided direction, e.g., building the material in the upward vertical direction after the deposition of an initial base or foundation layer to form a completed item or part. Complex geometries and hollowed-out interior surfaces are feasible with modern methods. Finishing refers to the process of achieving greater accuracy than possible by 3D printing alone by printing a slightly oversized version of the desired object to later remove excess material using a higher-resolution subtractive process. Multi-material printing allows for objects to be composed of complex and heterogenous arrangements of source materials, and may require specific materials being directed to specific voxels, e.g., referring to each of an array of elements of volume that constitute a notional three-dimensional space, inside the object volume.

### RFID

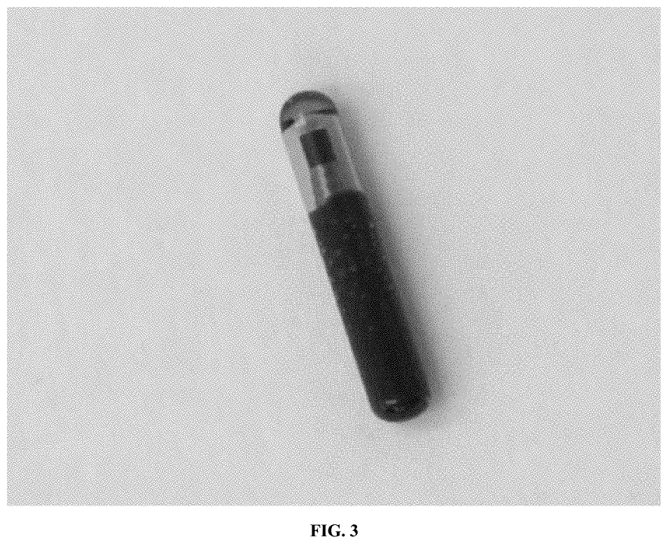

RFID, or Radio Frequency Identification, is a method of identifying and tracking tags attached to objects using electromagnetic fields. FIG. 3 shows an average RFID tag. There are two types—passive tags, where they collect energy from a nearby RFID reader's interrogating radio waves, and active tags, which have a local power source and may operate farther away from the RFID reader. They generally contain at least three components: an integrated circuit, a means of collecting DC power from the reader signal, and an antenna for receiving and transmitting the signal. In the oil and gas industry, they are used to track equipment being sent downhole, check flow rates, and estimate drill lengths, amongst other uses. They are notably vulnerable to being damaged during normal activity in the oil and gas industry, and must be physically protected without compromising its ability to transmit signals.

### RFID or Sensor

The phrase “RFID or Sensor” or any variation thereof refers to any of various items attached to downhole components during the drilling and extraction of oil and gas which provide data related to such items as the location, condition, operation, and environment of the component.

To retrofit a metal component with an RFID tag for thick walled components in oil and gas applications, a tag pocket may be drilled into the component. U.S. Pat. No. 9,089,902B2 entitled “Hole Drilling Apparatus and Process for Edge Mounted RFID Tag” directed to an apparatus and process to aid in drilling holes configured to receive and placed RFID tags. The drilling template compromises “a first hole configured to receive a through-bolt assembly, a second hole configured to receive a cam assembly, a third hole configured to receive a guide pin, a through-bolt assembly disposed through the first hole and configured to anchor the drilling template to an underlying material, such that the drilling template is rotatable about the through-bolt assembly; and a cam assembly disposed through the second hole and configured to rotate the drilling template about the through-bolt.” (U.S. Pat. No. 9,089,902B2).

U.S. Patent Publication No. 2009/0121895A1 describes and discloses various mounting assemblies for efficient and reliable assemblies for RFID for oilfield equipment. One method of installation of the RFID discloses in this patent is placing the RFID into a cavity created by drilling or milling the oilfield equipment. The RFID assembly is held in the position by using threaded parts such as screws. Another method that is disclosed in this patent is using a friction grip retainer that includes a ring-shaped support and a plurality of lugs extending therefrom. Another system for mounting the RFID assembly and disclosed in this patent is the disposing of the RFID in the cavity by applying epoxy layer or plastic or other durable, electrically isolating materials underneath the RFID and on the exterior surface of the RFID. A lid could be used to close the cavity and retain the RFID in it. In addition, a flexible retainer such as strap, string or wire is disposed about the exterior surface to retain the lid.

U.S. Pat. No. 9,940,492B2 title “Bond with RFID Chip Holder and Identifying Component” describes an apparatus to mount RFID to a component of a system associated with a well head. “The apparatus includes a band adapted to be coupled to the component; a buckle coupled to the band and located proximate to a first end of the band; a bolder coupled to the band, wherein the holder is positioned, or is adapted to be positioned, proximate to the first end; an electronic identifying device attached to the holder and adapted to identify the component; and an identifying component coupled to the band.”

U.S. Patent Publication No. 2010/0096455A1 title “Edge Mounted RFID Tag” describes a method to mount an RFID tag into the edge of an object. RFID tag is disposed in a tag pocket formed in the object, such as two surfaces of the RFID tag are left exposed after installation while the geometry of the object provides the structural protection for the RFID tag.

U.S. Patent Publication No. 2007/0018825A1 titled “Metal Tube Assembly and Radio Frequency Identification (RFID) Tag” discloses another method to mount RFID tags to the external surfaces of the tubes. The assembly is a molded ring made of epoxy resin or polyphenylene sulfide or those adhesives that exhibit an excellent chemical and mechanical strength similar or better than epoxy adhesives. RFID tag could be attached to the tube surface by means of thermo-shrinkable blanket, plastic rig or adhesive tape covering label or could be encapsulated on cylindrical or upset regions.

U.S. Pat. No. 6,486,783B1 titled “RFID Composite for Mounting on or Adjacent Metal Objects” discloses a composite containing an RFID that can be mounted on or in an adjacent metal object. “The composite includes a first RFID containing layer, and a foamable material layer held in proximity with the first layer. The foamable material layer expands in size and reduces in density, when subjected to external stimuli, such as heat or microwaves. The foamable layer may comprise an intumescent material, and may have RF radiation-absorbing material filler. Pressure sensitive adhesive, when the composite is in a label form, may be used to mount the composite on or adjacent a metal object after printing of the printable surface of the composite, and the foamable material layer is subjected to the external stimuli after printing and either before or after mounting on or adjacent the metal object.”

Other patents such as German Patent No. DE10227683B4, Japanese Patent No. JP3711026B2, U.S Pat. Nos. 4,822,987, 4,960,984, 4,978,917, 5,477,023, 5,777,303, 5,844,802, 6,016,255, 6,036,101, 6,122,704, 6,330,977, 8,378,841B2 and U.S. Patent. Publication No. 2016/067184A1 discloses identification of metal tubes by means of other detection elements such as for instance laser identification labels or bar codes, printing by chemical attack, by etching, semi-conductive integrated circuits attached by means of probes, electronic cards and the like.

Mounting of the above identification and tracking devices is very limited in thin-walled tubes, due to the structural limitations. In addition, RFID tags attached to the tubes needs to be protected from impact, environmental conditions, friction or the like.

### Thin-Walled Component

The phrase “thin-walled” refers to components which have limited wall thickness and are unable to undergo the traditional method of having a notch cut out of the body wall to house the RFID or sensor. Furthermore, the phrase “thin-walled component” refers to any of various items sent downhole during the drilling and extraction of oil and gas that have a thin body wall which is incapable of being drilled out in the traditional manner to create an area within the body wall to accommodate the sensor or RFID.

### Polymer-Based Top-Coat

The phrase “polymer-based top-coat” refers to any of various materials used as a sealant to hold the RFID or sensor in place within the opening, to protect the RFID or sensor from damage, and to allow the transmission from the RFID or sensor to be read.

It is known that there is a need in the oil and gas industry to provide a housing or enclosure for RFIDs or sensors attached to thin-walled components in order to protect them from physical harm. However, there is also a need for the RFID or sensor to remain able to transmit data, making it difficult to find a proper housing or enclosure that performs both duties efficiently.

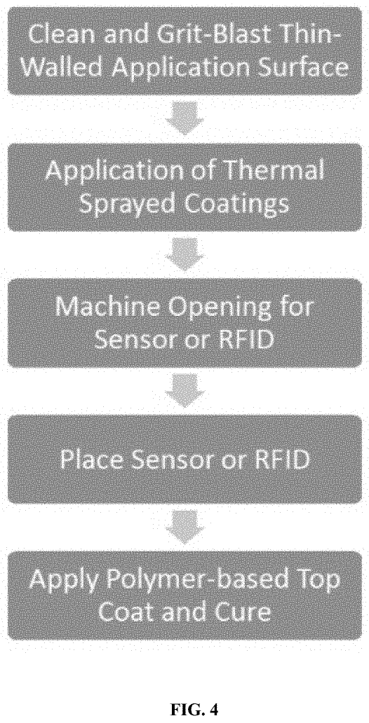

Accordingly, it would be desirable to develop a process in which a crystalline, amorphous, or partially amorphous coating is thermal sprayed onto a clean, grit-blasted substrate and is then machined in order to create an opening to receive the sensor and/or RFID. The opening is then covered with a polymer-based top-coat in order to close the housing or enclosure and could be partially infiltrated into the thermal sprayed coating. The thermal sprayed coating serves to protect the sensor or RFID, as well as provide other functions such as wear, corrosion, or erosion protection to the thin-walled components applied. FIG. 4 illustrates one form of the approach of the invention, where the above process is followed.

### Generic Description of the Embodiments

Amorphous metals are a new class of metal alloy-based materials that have a disordered, non-crystalline, and glassy structure. Amorphous metals may be created when metals or their alloys are: (1) cooled very quickly; or (2) have a unique composition that allows for the bypass of crystallization during solidification of the material. Rapid cooling of metals may be achieved upon exposure or application of metals to a supercooled liquid to reduce the temperature of the metals beneath the melting temperature Tₘ, and by exposure of the metals to an appropriate cooling rate to permit the metals in liquid phase to solidify with an amorphous structure.

The preparation of new amorphous metallic alloys that form amorphous structure below the glass transition temperature at a rate between 100 to 1,000 K/sec are described in U.S. Pat. No. 9,499,891. Earlier, glassy ingots with 5 mm diameter were produced from an alloy having a composition of 55% palladium, 22.5% lead, and 22.5% antimony, by using surface etching followed with several heating-cooling cycles. More recently, new alloys have been developed that form an amorphous structure at cooling rates as slow as 1 K/sec. These amorphous alloys can be cast into parts of up to several centimeters in thickness depending on the type of alloy used while continuing to retain an amorphous structure. Optimal glass-forming alloys may be based at least in part on zirconium and palladium, but alloys based on iron, titanium, copper, magnesium, and other metals are also known. These alloys have a high temperature difference between the glass transition temperature and the crystallization temperature. Some of the alloys have a difference between glass transition and crystallization of about less than 70 degrees, thus resulting in limitations encountered during manufacturing of these alloys.

Regardless of challenges associated with their formation, amorphous metals are often desirable in a number of applications due to their unique microstructure, which combines ultra-high strength, high hardness and ductility. They are also more corrosion resistant relative to conventional metals due to the lack of long-range periodicity, related grain boundaries and crystal defects such as dislocations down to the atomic scale. Moreover, they may be stronger than crystalline metals and can sustain larger reversible deformations than crystalline alloys. However, bulk consolidation of these amorphous powders is crucial to maintain amorphous structure.

Various representative amorphous coatings, formulations, and methods of manufacture thereof are disclosed in the following: U.S. Patent Publication No.: 2009/0087677 entitled “Amorphous Aluminum Alloy Coatings” directed to an amorphous aluminum alloy coating, which may include one of cerium, cobalt and/or molybdenum as alloying elements and be applied by a physical vapor deposition process to a desired thickness. The coating may supply improved corrosion resistance to a given environmental condition. A method is provided for forming an amorphous aluminum alloy coating involving: providing a vacuum chamber; providing a substrate for coating; providing a target material comprising aluminum and one or more alloying elements; and, for ejecting particles from said target and depositing an amorphous aluminum alloy coating wherein at least 50% of said alloy is amorphous.

U.S. Patent Publication No.: 2014/0345754 entitled “Molding and Separating of Bulk-Solidifying Amorphous Alloys and Composite Containing Amorphous Alloys” directed to a method to form and to separate bulk solidifying amorphous alloy or composite containing amorphous alloy. The forming and separating takes place at a temperature around the glass transition temperature or within the super cooled liquid region are provided. The method involves: processing a metal alloy to form a bulk solidifying amorphous alloy part, wherein the processing is performed in a manner such that a time-temperature profile during the processing does not traverse through a region bounding a crystalline region in a time-temperature-transformation (TTT) diagram of the metal alloy, and cutting a portion of the bulk solidifying amorphous alloy part by a cutting tool that is heated to a temperature greater than a glass transition temperature (T_{g}) of the metal alloy without previously cooling the bulk solidifying amorphous alloy part to a temperature near room temperature.

U.S. Patent Publication No.: 2014/0193662 entitled “Stainless Steel-and-Amorphous Alloy Composite and Method for Manufacturing” directed to a stainless steel-and-amorphous alloy composite includes a stainless-steel part and an amorphous alloy part. The stainless-steel part has nano-pores defined in a surface thereof. The amorphous alloy part is integrally bonded to the surface having the nano-pores. A method for manufacturing the composite is also described.

U.S. Patent Publication No.: 2016/0177430 entitled “Z-Group Amorphous Alloy Composition” directed to a highly corrosion-resistant Zr-group amorphous alloy composition. According to one, provided is the Zr-group amorphous alloy composition comprising: 67-78 atomic percent of Zr; 4-13 atomic percent of Al and/or Co; 15-24 atomic percent of Cu and/or Ni, wherein glass forming ability of the Zr-group amorphous alloy composition is at least 0.5 mm. The disclosed Zr-group amorphous alloy composition provides a highly corrosion-resistant Zr-group amorphous alloy composition containing a higher Zr content compared to existing amorphous alloys, and has only commercial metal elements, and therefore has superior industrial and economic utility and is easily rendered practical.

Although amorphous materials offer great promise for various applications, difficulties currently exist regarding extracting their full benefit because of challenges encountered in preparing amorphous metallic alloy parts. However, such drawbacks can be overcome through the production of bulk amorphous alloys by using additive manufacturing (AM). AM processes are typically designed to manufacture parts with high dimensional accuracy and quality. A number of scientists have reported AM of amorphous alloys. For instance, U.S. Pat. No. 8,333,922 discusses a method of producing three-dimensional bodies, which wholly or for selected parts consist of a composite of crystalline or nanocrystalline metal particles in a matrix of amorphous metal. Alloys described in this patent are titanium-based, zirconium-based and copper-based alloys. In addition, iron-based alloys including Fe—Ga—(Cr,Mo)—(P,C,B), Fe—C-Ln-B, Fe—B—Si—Nb, Fe—Ga—(P,B), Fe-(Al,Ga)—(P,C,B,Si,Ge) are also included.

Currently, RFIDs or sensors are commonly embedded in the walls of the drilling component, as there is enough material to machine out a small housing or enclosure sufficient to house the sensor or RFID. However, with drilling components that have thinner walls, there is not sufficient enough material to machine out an enclosure at the risk of damaging the structure of the component. Solutions attempted include using K10 (a tungsten carbide coating), as well as polyketone (high-performance thermoplastic polymers) as housings; however, they were too brittle or had poor wear resistance and failed during normal activity. Other solutions attempted included using smaller sensors or RFIDs, but the sensor or RFID was unable to remain in place during normal activity or was damaged during normal activity.

U.S. Patent Publication No.: 2012/0126008A1 entitled “Thin Mount RFID Tagging Systems” directed to a system including the RFID tag and techniques for installing the RFID tag onto the surface of a tool. The disclosed solution is a polymer-based system that couples the RFID an outer surface of a tool via an adhesive and/or coating that acts to retain the tag. The RFID tag is coated with a thin protective coating or casing material that may be disposed about a circumference. Moreover, after the RFID tag is attached to the surface by using a primer/adhesive material such as Lord Chemlok 2l3®, a protective casing material, such as urethane or two part liquid form polymers consisting of BASF ElastoCast™ 55090R Resin and BASF ElastoCast™ S55090T Isocyanate applied through a mixing machine such as the Gusmer H-2035 has been used. The protective casing can be brushed, rolled or sprayed.

U.S. Patent Publication No.: 2013/0056538A1 entitled “Identification Tags and Systems Suitable for Thin-Walled Components” directed to a RFID enclosing system that includes a coupling with an extended skirt that has an opening for the RFID tag. In one embodiment, the body is configured to deform to enable the RFID to be installed in the opening of the coupling by moving the identification tag in a radial direction, while in another embodiment the body is split into at least two pieces including a first piece configured to receive one end of the electronics module and a second piece configured to receive an opposite end of the electronics module. The skirt thickness could have the same thickness of the RFID such as 9 mm up to 26 mm.

U.S. Patent Publication No.: 2014/0069708A1 entitled “Coated Sensor or RFID Housing” directed to a method of protecting RFID sensors using ceramic based coatings. The housing involves a base metal and a double coating. “The double coating compromises a first coating of a porous ceramic on the base, the first coating being formed by an oxide ceramic with a lamellar structure and a second coating provided on the first coating to provide the double coating. The second coating is formed by a fluoropolymer varnish. The second coating is at least partially incorporated into the first coating, Wherein an outer surface structure of the double coating is an outer surface structure of the second coating over a major part of the outer surface structure of the double coating and the outer surface structure of the double coating is independent from a structure of the first coating.

U.S. Patent Publication No.: 2008/082699 entitled “RFID Transponder Enclosure for Harsh Environments” comprises a mounting RFIC enclosure that includes a shell member, an extension positioned with the shell member and configured for attachment to a correspondingly configured surface; a elastomeric member, positioned in the shell member. RFID assembly is positioned interior to the elastomeric member. In another embodiment, the embedded RFID is positioned between two portions of the elastomeric members.

In addition to mounting since in some application the objects are under severe environments, RFID tags attached to the tubes needs to be protected from impact, environmental conditions, friction or the like.

A proposed solution according to embodiments herein is to use thermal-sprayed materials to build up a coating on the outside diameter of the component that is strong enough to withstand the downhole activity, protect the sensor or RFID from damage, and allow an opening to be cut within the material for placement of the sensor or RFID. The thermal-sprayed coating may be metallic-based and may be crystalline, partially amorphous, or amorphous. The thermal sprayed coating could provide other functions such as wear, corrosion or erosion protection to the thin-walled components applied. A polymer-based top-coat may then be applied in order to both protect the sensor or RFID and keep it in place within the opening while also allowing the transmissions from the device to send.

### Embodiments

### Amorphous Metals—Generally

Of the type of materials discussed above regarding potential application and usage in additive manufacturing, metals, and more specifically amorphous metals, possess unique physical properties making their usage in additive manufacturing particularly desirable. Generally, an amorphous metal is a solid metallic material, often an alloy, having a disordered atomic-scale structure. While many metals are crystalline in their solid state (e.g., indicating a highly-ordered arrangements of atoms), amorphous metals are non-crystalline and have a glass-like structure. However, unlike common glasses, which are typically electrical insulators, amorphous metals have good electrical conductivity. Amorphous metals may be produced by several methods, including the following: extremely rapid cooling, physical vapor deposition (“PVD”), solid-state reaction, iron irradiation, and mechanical alloying. [Source: “Connectivity and glass transition in disordered oxide systems”; Ojovan, M. I.; Lee, W. B. E. (2010); Journal of Non-Crystalline Solids. 356 (44-49): 2534.]

Earlier, small batches of amorphous metals have been produced via a variety of rapid cooling methods, including sputtering molten metal onto a spinning metal disk (referred to as “melt spinning”). The rapid cooling, on the order of millions of degrees C. per second, is too fast for crystallization to occur and the material is “locked” or “frozen” into a glassy state. Recently, alloys with critical cooling rates low enough to permit formation of amorphous structure in thicker layers (e.g., over 1 millimeter) have been made; these are referred to as bulk metallic glasses (“BMG”).

### Physical Properties of Amorphous Metals Used in Manufacturing

Amorphous metal is typically an alloy, rather than a pure metal (defined herein as not being joined with any other metal or synthetic metal). Alloys, defined herein as a metal made by combining two or more metallic elements (to give greater strength or resistance to corrosion) contain atoms of significantly different size that leads to reduced free volume, and thus considerably higher viscosity than other metals and alloys, in a molten state. The increased viscosity of molten amorphous metal prevents its atoms from moving around enough to create an ordered lattice. Also, the material structure of an amorphous metal also results in reduced shrinkage during cooling, and resistance to plastic deformation. The absence of grain boundaries (defined herein as the interface between two grains, or crystallites, in a polycrystalline material; grain boundaries are 2D defects in a crystal structure and tend to decrease the electrical and thermal conductivity of the material), the weak areas of crystalline materials, provides improved resistance to wear and corrosion. [Source: “Microhardness and abrasive wear resistance of metallic glasses and nanostructured composite materials”; Gloriant, Thierry (2003); Journal of Non-Crystalline Solids. 316 (1): 96-103]. Also, amorphous metals, while classified as being glasses, are also considerably tougher and less brittle than oxide-based glasses and ceramics. And, “[t]hermal conductivity of amorphous materials is lower than that of crystalline metal. As formation of amorphous structure relies on fast cooling, this limits the maximum achievable thickness of amorphous structures.” [Source: https://en.wikipedia.org/wiki/Amorphous_metal; Retrieved on Apr. 23, 2019].

It is known that alloy chemistry influences, and potentially determines, the material properties of materials, such as density, toughness, and wear resistance. For example, it has been demonstrated that aluminum-based alloys may have a lower density with the addition of lithium and zirconium without sacrificing toughness, whereas aluminum-based alloys had a lower density with the addition of lithium, beryllium, boron, and magnesium but lacked the toughness the aforementioned composition possessed. [Source: EP Patent No. 0158769A]. Depending on what is required for the task, alloys can be tailored to what is needed through choosing the proper chemical composition.

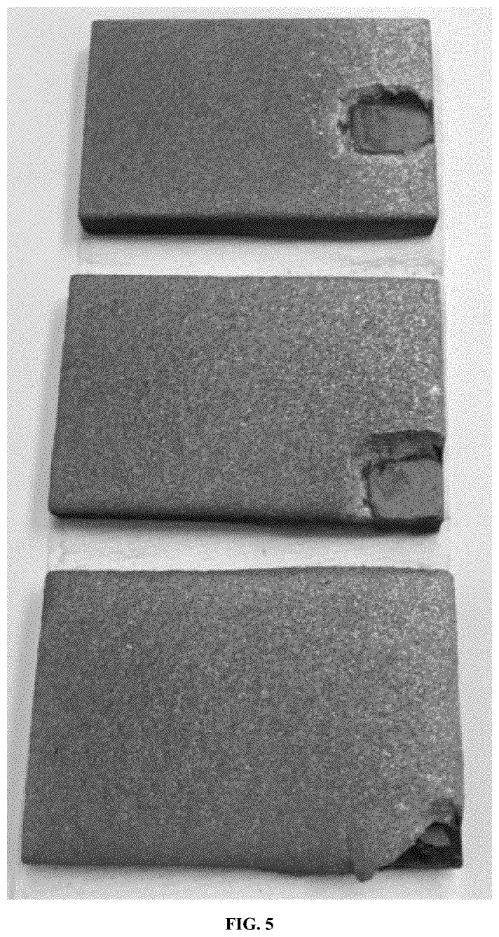

Coatings have been utilized for different wear and friction solutions for numerous years. A summary of the advantages, disadvantages, and limitations of different coating technologies is shown in the table below. For example, Electrolytic Hard Chrome (EHC) has many benefits, such as providing an excellent wear surface, a good corrosion barrier, and ability for surface restoration to dimensional tolerances during the repair and overhaul process. However, EHC has been systematically phased out due to its environmental and health hazard risks associated with the presence of hexacalent chromium (CrVI) byproducts of the process. In addition, EHC coatings cannot be used as enclosures for RFID due to the coating thickness limitations. On the other side, thermal spray technology is a dry coating technology that can be used both for initial production and for rebuilding worn components and based on the material chemistry can be sprayed as thick as needed for the RFID enclosures. FIG. 5 shows examples of varying thicknesses of thermal-sprayed coatings, ranging from 1.80 to 3.200 mil. in thickness.

TABLE 3
Summary of Coating Techniques

| Coating | Selected | Selected | Application |
|---|---|---|---|
| Technique | Advantages | Disadvantages | Limitation |
| Hard chrome | slide friction | uneven coatings | coating |
| (EHC) | protection | not | thickness: |
| | low tendency | environmentally | 0.05 to 0.2 |
| | of cold | friendly | mm |
| | welding | improper for | |
| | | impact stress and | |
| | | high edge pressure | |
| CVD | high wear | sensitive against | coating |
| | resistance | impact stress | thickness up |
| | | high deposition | to 50 pm |
| | | temperature | applicable |
| | | limited component | only for P/M |
| | | size | and HSS- |
| | | | Steels |
| PVD | high wear | expensive coating | Coating |
| | resistance | devices | thickness: 2-7 |
| | high material | limited component | μm |
| | variety | size | |
| Thermal | high wear | material and | coating |
| spraying | resistance | process depended | thickness: 50 |
| | coating large | adhesion | μm up to |
| | components | porous coatings | some mm |
| | possible | high roughness of | |
| | | the as-sprayed | |
| | | coating | |
| Welding | high wear | high thermal | Weld |
| | resistance | stresses | thickness: |
| | welding large | high dilution | 200 μm up to |
| | components | | some mm |

Several different coatings with different properties and characteristics exist. A summary of different materials that could be used for RFID enclosures is shown in the following table.

TABLE 4
Summary of Coating Materials Properties

| Coating materials | Wear resistance | Friction | Build-up |
|---|---|---|---|
| Polymer | − | + | + |
| Metal | − | 0 | + |
| Solid Lube | − | + | − |
| Cermets | + | − | − |
| Ceramic | + | − | − |
| Amorphous | + | + | + |

The amorphous-based coatings can be adjusted in chemistry to a variety of application specifications to meet the specific requirements, such as high wear resistance, low friction, low residual stresses, high density to ensure sealing, high ductility, and no RFID signal distraction.

A proposed solution according to embodiments herein is to use thermal-sprayed materials to build up a coating on the outside diameter of the component that is strong enough to withstand the downhole activity, protect the sensor or RFID from damage, and allow an opening to be cut within the material for placement of the sensor or RFID. The thermal-sprayed coating may be metallic-based in case the sensor or RFID has an isolated cover, or ceramic-based in case the sensor or RFID is not isolated. The coating may be crystalline, partially amorphous, or amorphous. Different kinds of thermal spraying processes may be used, including but not limited to high velocity oxygen fuel (HVOF), plasma spraying, and twin wire arc spraying (TWAS), where the feedstock could be in powder or wire form. In one embodiment the enclosure may be applied in a patch form, while in another embodiment it may be applied in an annular ring form, as illustrated in FIG. 6. In all cases, the surface of the area to be sprayed has to be cleaned and grit-blasted to ensure a good adhesion between the substrate and the amorphous thermal sprayed coatings. The thickness of the enclosure may vary depending on the size of the RFID or sensor thickness. In some embodiments, the thickness may be in the range of 5 to 120 mils.

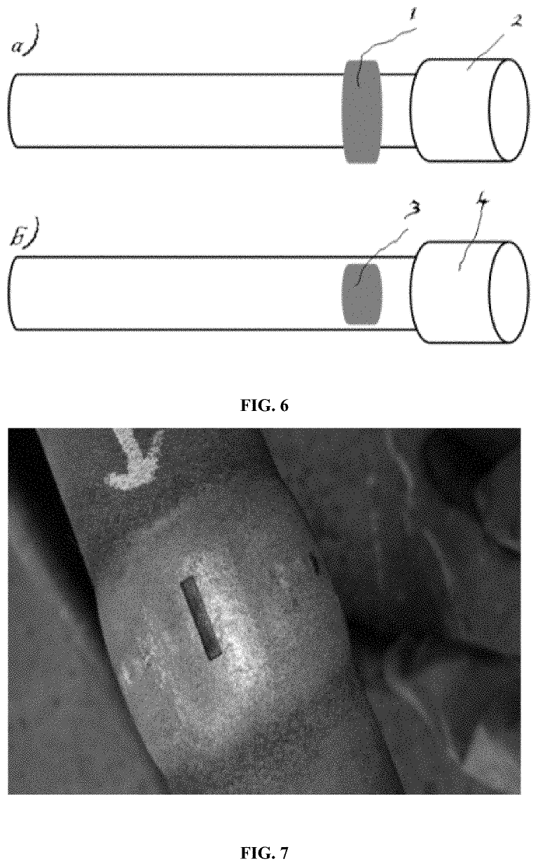

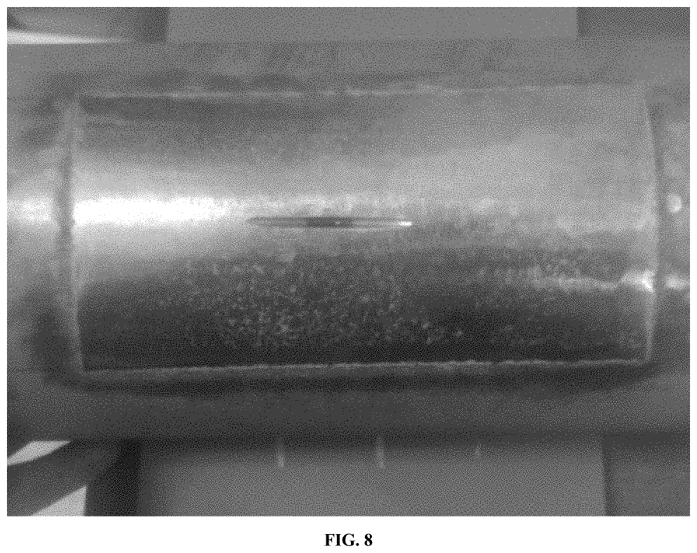

A small enclosure or housing compartment may be machined out and custom-fit to the sensor or RFID, as displayed in FIG. 7 and FIG. 8 A polymer-based top-coat may then be applied in order to both protect the sensor or RFID and keep it in place within the opening while also allowing the transmissions from the device to still be able to be read. The top-coat may be partially infiltrated into the thermal sprayed coating. The protective enclosure may also be sprayed, rolled, or brushed onto the opening to fill it and protect the RFID or sensor.

The resulting embodiments are able to be tracked downhole and various types of data gathered. The thermal-sprayed housing/enclosure is able to withstand the downhole environment, remain attached to the exterior of the component, and protect the sensor or RFID from damage, while allowing the transmissions from the sensor or RFID to be read. The machined opening allows the RFID or sensor to be placed in a custom-fitted space to hold the RFID or sensor in place within the housing/enclosure. The sensor or RFID is able to remain attached to the component while also being able to successfully transmit various data to the reader. The polymer-based top-coat is able to hold the sensor or RFID in place within the opening, protect the sensor or RFID from damage, and allow the transmission of the various data from the sensor or RFID to the reader.

Based on testing the product made from the process described, is readable even after the severe cleaning process such as brushing. The product went multiple brushing processes and a reader has been used to check the signals. Coatings were full in-tact and the tags were all readable.

### Advantages

Advantages of the disclosed embodiments include creating a housing/enclosure applicable on almost all thin-walled materials, where the current solution of attaching RFIDs or sensors onto a component through embedding it into the outer wall is not applicable. The disclosed embodiments also have no heat effect to the aforementioned thin-walled components and are applicable even on complex geometries. Moreover, applying the coating through thermal spraying can be selected to create not only a housing, but create an amorphous structure coating the thin-walled component that has superior corrosion resistance, ultrahigh strength coupled with high toughness, and high wear resistance depending to the chemical composition selected.

The disclosed thermal-sprayed coating also benefits from the random organization nature of amorphous metallic alloys generally, which makes such alloys, free from the typical defects associated with crystalline structures, such as dislocations and grain boundaries. This disordered, dense atomic arrangement and the absence of crystal slip systems determines the unique structural and functional properties of amorphous alloys. Thus, amorphous metals are more wear resistant compared to conventional metals due to the lack of long-range periodicity, related grain boundaries and crystal defects such as dislocations. In addition, they are stronger than crystalline metals and they can sustain larger reversible deformations than crystalline alloys. Due to their unique microstructure, amorphous metals combine ultra-high strength, high hardness and ductility in one single material.

As presented and discussed earlier, amorphous metal alloys can be tailored to fit specific needs while still retaining the benefits of their amorphous structures, including adapting the composition to result in a lower density. As indicated by evaluating the disclosed composition, the chemical composition of the thermal-sprayed metal-based coating can be selected to result in an enclosure/housing for RFIDs or sensors that is also resistant to corrosion and wear damage, as well as high strength and toughness.

### EXAMPLES

### Example 1

Square 2″×2″ patches and 2″ wide circumferential patches of amorphous alloys were sprayed on pipes 4″ in diameter with different thicknesses of approximately 0.15 inches. The coatings were notched to create an opening for RFID inserts. After RFID inserting in the opening, the opening was filled with three different kind of polymers and cured. The product went multiple brushing processes and a reader has been used to check the signals.

TABLE 5
Summary of Testing Results

| Second Layer | After one brushing | After four brushings |
|---|---|---|
| Polymer #1 | 6 out of 10 patches were | — |
| | readable | |
| Polymer #2 | 9 out of 10 were readable | 8 out of 10 were readable |
| Polymer #3 | 10 out of 10 were readable | 10 ut of 10 were readable |

In an embodiment, the amorphous alloy could be mixed with unstabilized zirconium oxide (zirconia). An unstabilized zirconia contains no stabilizing agents. The compositions of different unstabilized zirconia are shown in Table 6.

TABLE 6
Compositions of examples of unstabilized zirconia

| Grades | 1 | 2 | 3 |
|---|---|---|---|
| Y₂O₃(mol %) | 0 | 0 | 0 |

Powder characteristics

| | | | |
|---|---|---|---|
| ZrO₂(wt %) | 99.9 | 99.9 | 99.9 |
| Al₂O₃(wt %) | 0.001 | 0.001 | 0.001 |
| SiO₂(wt %) | 0.01 | 0.01 | 0.01 |
| TiO₂(wt %) | 0.005 | 0.005 | 0.005 |
| Fe₂O₃(wt %) | 0.005 | 0.005 | 0.005 |
| Specific surface | 5 | 10 | 10 |
| area(m²/g) | | | |
| D50(μm) | 17 | 17 | 0.2 |
| Primary particle | 150-250 | 80-120 | 80-120 |
| size (nm) | | | |

All references, including granted patents and patent application publications, referred herein are incorporated herein by reference in their entirety.

Accordingly, the foregoing description should not be read as pertaining only to the precise structures described and illustrated in the accompanying drawings, but rather should be read consistent with and as support to the accompanying drawings, but rather should be read consistent with and as support to the following claims which are to have their fullest and fair scope.

What is claimed is:

1. A device comprising a substrate and a first layer on the substrate, the first layer comprising an amorphous metal alloy, the first layer having a sensor in an opening within the first layer, wherein the first layer (a) does not reduce hardness, strength and toughness of the substrate; (b) has a coefficient of friction that is lower than that of the substrate; and (c) does not change a signal strength of a signal emitted from the sensor by more than 50%.

2. The device of claim 1, wherein the substrate comprises a metal.

3. The device of claim 1, further comprising a second layer covering the opening.

4. The device of claim 3, wherein the second layer comprises a polymer.

5. The device of claim 1, wherein the device comprises a component for drilling.

6. The device of claim 5, wherein the component comprises a pipe.

7. The device of claim 1, wherein the amorphous metal alloy comprises F_{100-(a+b+c)}(XₐY_{b}Z_{c}), wherein the X and the Y are selected from the group consisting of tungsten, molybdenum, chromium, niobium, vanadium and combinations of tungsten, molybdenum, chromium, niobium, vanadium, and titanium, said X being present in the range of 10-50 at. %, the Y is in the range of 10 to 30 at. %, while the Z is selected from the group consisting of boron, carbon, and combinations thereof, said third component being present in an amount of from about 0.5 to about 10 at. %.

8. The device of claim 1, wherein the amorphous metal alloy comprises F_{100-(a+b+c+d)}CrₐMo_{b}C_{c}B_{d}, wherein a is in the range of 10 at. % to 35 at. %; b is in the range of 10 at. % to 20 at. %, c is in the range of 2 at. % to 5 at. %; and d is in the balance of 0.5% at. % to 3.5 at. %.

9. The device of claim 1, wherein the amorphous metal alloys comprises Fe_{100-(a+b+c+d)}(Crₐ(Mn+Mo)_{b}(W+Si)_{c}(C+B)_{d}), wherein a is in the range of 10 to 30 at. %, b is in the range of 10 to 20 at. %, c is in the range of 2 to 10 at. %, and d is in the range of 2 to 10 at. %.

10. The device of claim 7, wherein the first layer further comprises a plurality of unstabilized zirconium oxide particles.

11. The device of claim 1, wherein the sensor comprises an RFID sensor.

12. The device of claim 1, wherein the amorphous metal alloy comprises a hardness value of 750-1,400 HV.

13. The device of claim 1, wherein the coefficient of friction of the first layer is less than 0.5.

14. A method comprising manufacturing a device comprising obtaining a substrate, depositing a first layer on the substrate, and inserting a sensor in an opening in the first layer, the first layer comprising an amorphous metal alloy, wherein the first layer (a) does not reduce hardness, strength and toughness of the substrate; (b) has a coefficient of friction that is lower than that of the substrate; and (c) does not change a signal strength of a signal emitted from the sensor by more than 50%.

15. The method of claim 14, further comprising making the opening in the first layer.

16. The method of claim 14, wherein the substrate comprises a metal.

17. The method of claim 14, further comprising deposition a second layer covering the opening.

18. The method of claim 17, wherein the second layer comprises a polymer.

19. The method of claim 14, wherein the device comprises a component for drilling.

20. The method of claim 19, wherein the component comprises a pipe.

21. The method of claim 14, wherein the amorphous metal alloy comprises F_{100-(a+b+c)}(XₐY_{b}Z_{c}) wherein the X and the Y are selected from the group consisting of tungsten, molybdenum, chromium, niobium, vanadium and combinations of tungsten, molybdenum, chromium, niobium, vanadium, and titanium, said X being present in the range of 10-50 at. %, the Y is in the range of 10 to 30 at. %, while the Z is selected from the group consisting of boron, carbon, and combinations thereof, said third component being present in an amount of from about 0.5 to about 10 at. %.

22. The method of claim 14, wherein the amorphous metal alloy comprises F_{100-(a+b+c+d)}CrₐMo_{b}C_{c}B_{d}, wherein a is in the range of 10 at. % to 35 at. %; b is in the range of 10 at. % to 20 at. %, c is in the range of 2 at. % to 5 at. %; and d is in the balance of 0.5% at. % to 3.5 at. %.

23. The method of claim 14, wherein the amorphous metal alloys comprises Fe_{100-(a+b+c+d)}(Crₐ(Mn+Mo)_{b}(W+Si)_{c}(C+B)_{d}), wherein: a is in the range of 10 to 30 at. %, b is in the range of 10 to 20 at. %, c is in the range of 2 to 10 at. %, and d is in the range of 2 to 10 at. %.

24. The composition of claim 14, wherein the first layer further comprises a plurality of unstabilized zirconium oxide particles.

25. The method of claim 14, wherein the sensor comprises an RFID sensor.

26. The method of claim 14, wherein the amorphous metal alloy comprises a hardness value of 750-1,400 HV.

27. The method of claim 14, wherein the coefficient of friction of the first layer is less than 0.5.
